(19) United States
(12) Patent Application Publication
(10) Pub. No.: US 2016/0173180 A1
(43) Pub. Date: Jun. 16, 2016

(54) TWO-DIMENSIONAL DISCRETE FOURIER TRANSFORM (2D-DFT) BASED CODEBOOK FOR ELEVATION BEAMFORMING

(71) Applicants: Peng CHENG, San Diego, CA (US); Chao WEI, San Diego, CA (US); Neng WANG, San Diego, CA (US); Jilei HOU, San Diego, CA (US); QUALCOMM INCORPORATED, San Diego, CA (US)

(72) Inventors: Peng Cheng, Beijing (CN); Chao Wei, Beijing (CN); Neng Wang, Beijing (CN); Jilei Hou, Beijing (CN)

(21) Appl. No.: 14/889,108

(22) PCT Filed: Jun. 12, 2014
(86) PCT No.: PCT/CN2014/079735

§ 371 Date: Nov. 4, 2015

(30) Foreign Application Priority Data
Jun. 13, 2013 (CN) PCT/CN2013/077164

(51) Int. Cl. H04B 7/04; H04L 27/26

(52) U.S. Cl. CPC H04B 7/0478; H04L 27/2628; H04B 7/0417

(57) ABSTRACT

The present disclosure relates to systems and methods for a two-dimensional discrete Fourier transform based codebook for elevation beamforming. A two-dimensional discrete Fourier transform based codebook is determined for elevation beamforming. The codebook supports single stream codewords and multistream codewords. The two-dimensional discrete Fourier transform based codebook is generated by stacking the columns of the matrix product of two discrete Fourier transform codebook matrices. The codebook size may be flexibly designed based on required beam resolution in azimuth and elevation. A best codebook index is selected from the generated two-dimensional discrete Fourier transform based codebook. The selected codebook index is provided in a channel state information report. The channel state information report is transmitted to a base station.

### RELATED APPLICATIONS AND PRIORITY CLAIMS

This application is related to and claims priority from PCT international application serial number PCT/CN2013/077164 filed Jun. 13, 2013, for “TWO-DIMENSIONAL DISCRETE FOURIER TRANSFORM (2D-DFT) BASED CODEBOOK FOR ELEVATION BEAMFORMING.”

### TECHNICAL FIELD

The present disclosure relates generally to wireless communication systems. More specifically, the present disclosure relates to systems and methods for a two-dimensional discrete Fourier transform (2D-DFT) based codebook for elevation beamforming.

### BACKGROUND

Wireless communication systems are widely deployed to provide various types of communication content such as voice, video, data, and so on. These systems may be multiple-access systems capable of supporting simultaneous communication of multiple terminals with one or more base stations.

A problem that must be dealt with in all communication systems is fading or other interference. There may be problems with decoding the signals received. One way to deal with these problems is by utilizing beamforming. With beamforming, instead of using each transmit antenna to transmit a spatial stream, the transmit antennas each transmit a linear combination of the spatial streams, with the combination being chosen so as to optimize the response at the receiver.

Smart antennas are arrays of antenna elements, each of which receive a signal to be transmitted with a predetermined phase offset and relative gain. The net effect of the array is to direct a (transmit or receive) beam in a predetermined direction. The beam is steered by controlling the phase and gain relationships of the signals that excite the elements of the array. Thus, smart antennas direct a beam to each individual mobile unit (or multiple mobile units) as opposed to radiating energy to all mobile units within a predetermined coverage area (e.g., 120°) as conventional antennas typically do. Smart antennas increase system capacity by decreasing the width of the beam directed at each mobile unit and thereby decreasing interference between mobile units. Such reductions in interference result in increases in signal-to-interference and signal-to-noise ratios that improve performance and/or capacity. In power controlled systems, directing narrow beam signals at each mobile unit also results in a reduction in the transmit power required to provide a given level of performance.

Wireless communication systems may use beamforming to provide system-wide gains. In beamforming, multiple antennas on the transmitter may steer the direction of transmissions towards multiple antennas on the receiver. Beamforming may reduce the signal-to-noise ratio (SNR). Beamforming may also decrease the amount of interference received by terminals in neighboring cells. Benefits may be realized by providing improved beamforming techniques.

The use of codebooks allows a wireless communication device to indicate to a base station the format of channel state information (CSI) feedback. Different codebooks can provide different benefits. For example, some codebooks provide increased payloads, some provide high feedback accuracy and some codebooks provide low overhead. Benefits may also be realized by using adaptive codebooks for channel state information (CSI) feedback.

### SUMMARY

A method for channel state information reporting is described. A two-dimensional discrete Fourier transform based codebook is determined for elevation beamforming. The codebook supports single stream codewords and multistream codewords. The two-dimensional discrete Fourier transform based codebook is generated. A best codebook index is selected from the generated two-dimensional discrete Fourier transform based codebook. The selected codebook index is provided in a channel state information report. The channel state information report is transmitted to a base station.

The method may be performed by a wireless communication device. The wireless communication device may report two codebook indexes ic1 and ic2 for a W1 matrix and a W2 matrix. The channel state information for the W1 matrix may be built by stacking the columns of the matrix product of two discrete Fourier transform codebook matrices. A codebook size of the W1 matrix may be flexibly designed based on required beam resolution in azimuth and elevation. Beams of the W1 matrix be grouped into multiple groups with a grid of beams from both elevation and azimuth. Beam groups may be overlapped or non-overlapped.

A wrap around may be used. The W2 matrix may be a co-phasing matrix. A matrix from Rel-10 8Tx may be reused as the W2 matrix.

A method for transmission by a base station is also described. It is determined that a wireless communication device will use a two-dimensional discrete Fourier transform based codebook. The codebook supports single stream codewords and multistream codewords. A two-dimensional discrete Fourier transform based codebook is generated. A channel state information report is received from the wireless communication device. The channel state information report is decoded. A codebook index is obtained from the decoded channel state information report. A first matrix and a second matrix are generated based on the codebook index. Elevation beamforming is performed for the wireless communication device in a next scheduled downlink transmission using the first matrix and the second matrix.

An apparatus for channel state information reporting is also described. The apparatus includes a processor, memory in electronic communication with the processor and instructions stored in the memory. The instructions are executable by the processor to determine a two-dimensional discrete Fourier transform based codebook for elevation beamforming. The codebook supports single stream codewords and multistream codewords. The instructions are also executable by the processor to generate the two-dimensional discrete Fourier transform based codebook. The instructions are further executable by the processor to select a best codebook index from the generated two-dimensional discrete Fourier transform based codebook. The instructions are also executable by the processor to provide the selected codebook index in a channel state information report. The instructions are further executable by the processor to transmit the channel state information report to a base station.

A base station used for transmitting signals is described. The base station includes a processor, memory in electronic communication with the processor and instructions stored in the memory. The instructions are executable by the processor to determine that a wireless communication device will use a two-dimensional discrete Fourier transform based codebook. The codebook supports single stream codewords and multistream codewords. The instructions are also executable by the processor to generate a two-dimensional discrete Fourier transform based codebook. The instructions are further executable by the processor to receive a channel state information report from the wireless communication device. The instructions are also executable by the processor to decode the channel state information report. The instructions are further executable by the processor to obtain a codebook index from the decoded channel state information report. The instructions are also executable by the processor to generate a first matrix and a second matrix based on the codebook index. The instructions are further executable by the processor to perform elevation beamforming for the wireless communication device in a next scheduled downlink transmission using the first matrix and the second matrix.

An apparatus configured for channel state information reporting is also described. The apparatus includes means for determining a two-dimensional discrete Fourier transform based codebook for elevation beamforming. The codebook supports single stream codewords and multistream codewords. The apparatus also includes means for generating the two-dimensional discrete Fourier transform based codebook. The apparatus further includes means for selecting a best codebook index from the generated two-dimensional discrete Fourier transform based codebook. The apparatus also includes means for providing the selected codebook index in a channel state information report. The apparatus further includes means for transmitting the channel state information report to a base station.

An apparatus is described. The apparatus includes means for determining that a wireless communication device will use a two-dimensional discrete Fourier transform based codebook. The codebook supports single stream codewords and multistream codewords. The apparatus also includes means for generating a two-dimensional discrete Fourier transform based codebook. The apparatus further includes means for receiving a channel state information report from the wireless communication device. The apparatus also includes means for decoding the channel state information report. The apparatus further includes means for obtaining a codebook index from the decoded channel state information report. The apparatus also includes means for generating a first matrix and a second matrix based on the codebook index. The apparatus further includes means for performing elevation beamforming for the wireless communication device in a next scheduled downlink transmission using the first matrix and the second matrix.

A computer-program product including a non-transitory tangible computer-readable medium having instructions thereon is also described. The instructions include code for causing a wireless communication device to determine a two-dimensional discrete Fourier transform based codebook for elevation beamforming. The codebook supports single stream codewords and multistream codewords. The instructions also include code for causing the wireless communication device to generate the two-dimensional discrete Fourier transform based codebook. The instructions further include code for causing the wireless communication device to select a best codebook index from the generated two-dimensional discrete Fourier transform based codebook. The instructions also include code for causing the wireless communication device to provide the selected codebook index in a channel state information report. The instructions further include code for causing the wireless communication device to transmit the channel state information report to a base station.

A computer-program product including a non-transitory tangible computer-readable medium having instructions thereon is described. The instructions include code for causing a base station to determine that a wireless communication device will use a two-dimensional discrete Fourier transform based codebook. The codebook supports single stream codewords and multistream codewords. The instructions also include code for causing the base station to generate a two-dimensional discrete Fourier transform based codebook. The instructions further include code for causing the base station to receive a channel state information report from the wireless communication device. The instructions also include code for causing the base station to decode the channel state information report. The instructions further include code for causing the base station to obtain a codebook index from the decoded channel state information report. The instructions also include code for causing the base station to generate a first matrix and a second matrix based on the codebook index. The instructions further include code for causing the base station to perform elevation beamforming for the wireless communication device in a next scheduled downlink transmission using the first matrix and the second matrix

### BRIEF DESCRIPTION OF THE DRAWINGS

FIG. 1 shows a wireless communication system;

FIG. 2 is a diagram illustrating vertical sectorization in a wireless communication system;

FIG. 3 is a block diagram illustrating a radio network operating in accordance with the systems and methods disclosed herein;

FIG. 4 is a diagram illustrating two-dimensional antenna arrays for elevation beamforming;

FIG. 5 illustrates the possible codebook structures for a two-dimensional (2D) antenna array;

FIG. 6 is a block diagram illustrating that grouping of beams in the W1 matrix;

FIG. 7 is a block diagram illustrating a two-dimensional (2D) antenna array;

FIG. 8 illustrates steering vectors for use in a two-dimensional discrete Fourier transform (2D-DFT) based codebook for a wireless communication device;

FIG. 9 is a flow diagram of a method for channel state information (CSI) reporting using a two-dimensional discrete Fourier transform (2D-DFT) based codebook;

FIG. 10 is a flow diagram of a method for obtaining channel state information (CSI) reporting using a two-dimensional discrete Fourier transform (2D-DFT) based codebook;

FIG. 11 is a block diagram of a transmitter and receiver in a multiple-input and multiple-output (MIMO) system;

FIG. 12 illustrates certain components that may be included within a wireless communication device; and

FIG. 13 illustrates certain components that may be included within a base station.

### DETAILED DESCRIPTION

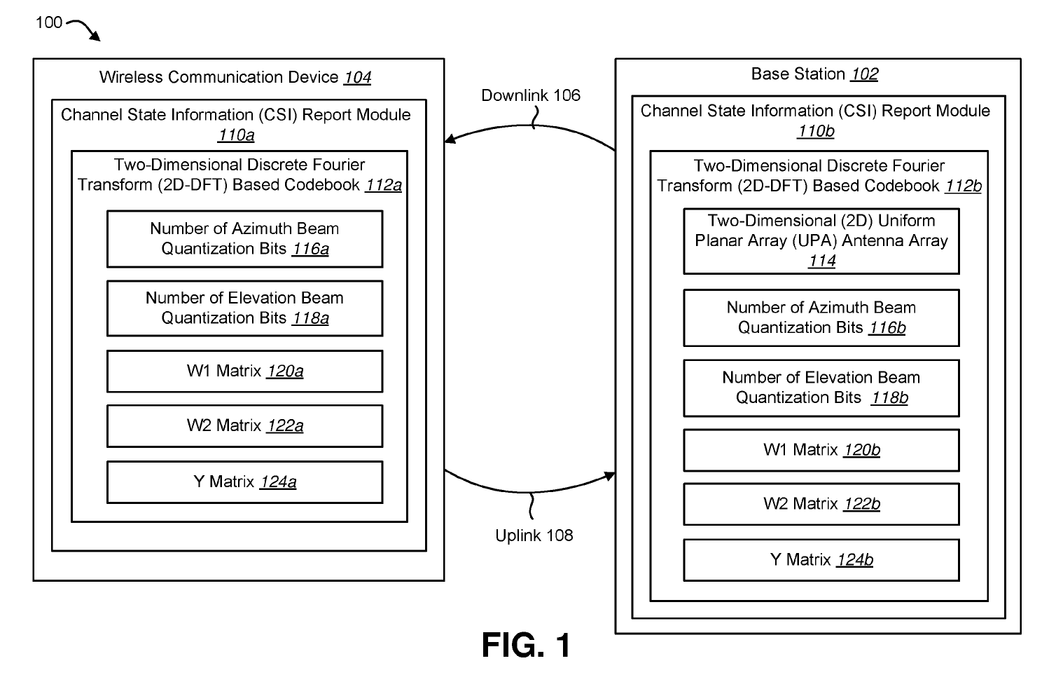

FIG. 1 shows a wireless communication system 100. Wireless communication systems 100 are widely deployed to provide various types of communication content such as voice, data and so on. A wireless communication system 100 may include multiple wireless devices. A wireless device may be a base station 102 or a wireless communication device 104. Both a wireless communication device 104 and a base station 102 may be configured to use a two-dimensional discrete Fourier transform (2D-DFT) based codebook 112a-b for elevation beamforming.

A base station 102 is a station that communicates with one or more wireless communication devices 104. A base station 102 may also be referred to as, and may include some or all of the functionality of, an access point, a broadcast transmitter, a NodeB, an evolved NodeB (eNB), etc. The term “base station” will be used herein. Each base station 102 provides communication coverage for a particular geographic area. A base station 102 may provide communication coverage for one or more wireless communication devices 104. The term “cell” can refer to a base station 102 and/or its coverage area, depending on the context in which the term is used.

Communications in a wireless communication system 100 (e.g., a multiple-access system) may be achieved through transmissions over a wireless link. Such a communication link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may utilize MIMO. A MIMO system may support both time division duplex (TDD) and frequency division duplex (FDD) systems. In a TDD system, uplink 108 and downlink 106 transmissions are in the same frequency region so that the reciprocity principle allows the estimation of the downlink 106 channel from the uplink 108 channel. This enables a transmitting wireless device to extract transmit beamforming gain from communications received by the transmitting wireless device.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, single-carrier frequency division multiple access (SC-FDMA) systems, 3^{rd} Generation Partnership Project (3GPP) Long Term Evolution (LTE) systems and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA. UTRA, E-UTRA, GSM, UMTS and Long Term Evolution (LTE) are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems and mobile devices.

In 3GPP Long Term Evolution (LTE), a wireless communication device 104 may be referred to as a “user equipment” (UE). A wireless communication device 104 may also be referred to as, and may include some or all of the functionality of, a terminal, an access terminal, a subscriber unit, a station, etc. A wireless communication device 104 may be a cellular phone, a personal digital assistant (PDA), a wireless device, a wireless modem, a handheld device, a laptop computer, etc.

A wireless communication device 104 may communicate with zero, one or multiple base stations 102 on the downlink 106 and/or uplink 108 at any given moment. The downlink 106 (or forward link) refers to the communication link from a base station 102 to a wireless communication device 104, and the uplink 108 (or reverse link) refers to the communication link from a wireless communication device 104 to a base station 102.

The use of channel quality indicators (CQI) is an important component of LTE channel state information (CSI) feedback reporting that may enable a base station 102 to perform scheduling and modulation and coding scheme (MCS) selection in a way that reflects current channel conditions of a wireless communication device 104. Both the wireless communication device 104 and the base station 102 may use a codebook (a set of pre-agreed parameters) for channel state information (CSI) reports. The codebook instructs the receiving device on how to interpret received channel state information (CSI) reports, including what information is included in the channel state information (CSI) report and the formatting of the channel state information (CSI) report.

The current LTE Rel-8/Rel-10 codebook is designed based on a one-dimensional (1D) uniform linear array (ULA) antenna array. To improve transmissions in LTE, elevation beamforming may be applied. Elevation beamforming refers to the use of a variable elevation tilt of a transmit signal by a transmit antenna. The performance of the LTE Rel-8/Rel-10 codebook based on a one-dimensional (1D) uniform linear array (ULA) antenna array may degrade under elevation beamforming, due to the use of a two-dimensional (2D) uniform planar array (UPA) antenna array. Thus, a high-efficiency, low-overhead codebook is needed for elevation beamforming, especially for the use of eight-port two-dimensional (2D) uniform planar array (UPA) antenna arrays 114 that are used in 3GPP.

Both the wireless communication device 104 and the base station 102 may include a channel state information (CSI) report module 110a-b. The channel state information (CSI) report module 110 may be used to transmit and/or receive channel state information (CSI) reports. Thus, in one configuration the wireless communication device 104 may use the channel state information (CSI) report module 110a to generate and transmit a channel state information (CSI) report to the base station 102 and the base station 102 may use the channel state information (CSI) report module 110b to receive and decode a channel state information (CSI) report from the wireless communication device 104.

A channel state information (CSI) report module 110 may include a two-dimensional discrete Fourier transform (2D-DFT) based codebook 112a-b. The proposed two-dimensional discrete Fourier transform (2D-DFT) based codebook 112 is well matched with a two-dimensional (2D) uniform planar array (UPA) antenna array 114 (such as an eight-port antenna array). The two-dimensional discrete Fourier transform (2D-DFT) based codebook 112 may reuse the LTE R10 8Tx dual codebook structure. The two-dimensional discrete Fourier transform (2D-DFT) based codebook 112 may support both single stream codewords and multistream codewords.

The codebook structure for LTE Rel-10 8Tx (i.e., eight transmit antennas used by the base station 102) has been defined. This codebook structure defines a dual codebook structure tailored to X-pol antenna structures, which is motivated by a preference from operators and by the large form factor of 8Tx-ULA (uniform linear array) antenna arrays. The codebook structure for 8Tx defines a block diagonal grid of beams (GoB) structure W=W1·W2. In the GoB structure, the W1 matrix 120a-b is an 8×2Nb matrix defined as

$$W 1 = [ \begin{matrix}X & 0 \\ 0 & X\end{matrix} ] .$$

Within the matrix W1 120, X is a 4×Nb matrix defining the grid of beams (GoB) for each polarization, where Nb represents the number of beams within a beam group. Since the W1 matrix 120 is reported only for wideband, having multiple overlapping beam groups per W1 matrix 120 allows the W2 matrix 122a-b to select among the optimal beams within the beam group on a per-subband basis. The W2 matrix 122 is a 2Nb×r matrix. The W2 matrix 122 performs beam selection within the beam group and co-phasing. In the W2 matrix 122, r denotes the selected transmission rank.

The use of a two-dimensional discrete Fourier transform (2D-DFT) based codebook 112 for elevation beamforming may provide flexibility for joint optimization of elevation and azimuth. The two-dimensional discrete Fourier transform (2D-DFT) based codebook 112 may also reduce channel state information (CSI) feedback overhead. The two-dimensional discrete Fourier transform (2D-DFT) based codebook 112 may include a number of azimuth beam quantization bits 116a-b and a number of elevation beam quantization bits 118a-b, which affect the size of the two-dimensional discrete Fourier transform (2D-DFT) based codebook 112. The codebook size will be discussed below. For quantization bit selection, the number of quantization bits in the azimuth domain and the elevation domain may be selected/chosen.

In a first option, 8 oversampling may be used in both azimuth and elevation. Since 8 oversampling is used in both azimuth and elevation, 16 beams can be formed in azimuth and 16 beams can be formed in elevation (resulting in 256 total beams). If 8 beams are in each group, and 4 beams overlap with the neighbor group, there will be a total of 64 groups. In this configuration, a 6-bit feedback is used for the W1 matrix 120, a 3-bit feedback is used for the Y matrix 124a-b and a 2-bit feedback is used for the W2 matrix 122, resulting in 11 bits of feedback.

In a second option, 8 oversampling may be used in azimuth and 2 oversampling may be used in elevation. There may be 8 beams per group and 4 beams overlap between consecutive groups. Thus, there are a total of 16 groups. In this configuration, a 4-bit feedback is used for the W1 matrix 120, a 3-bit feedback is used for the Y matrix 124 and a 2-bit feedback is used for the W2 matrix 122, resulting in 9 bits of total feedback.

In a third option, 4 oversampling may be used in azimuth and 2 oversampling may be used in elevation. There may be 8 beams per group, and 4 beams overlap between consecutive groups. Thus, there are a total of 8 groups. In this configuration, a 3-bit feedback is used for the W1 matrix 120, a 3-bit feedback is used for the Y matrix 124 and a 2-bit feedback is used for the W2 matrix 122, resulting in 8 bits of total feedback. The third option uses the same codebook size as the current R10 8Tx codebook.

In a fourth option, 4 oversampling may be used in azimuth and 2 oversampling may be used in elevation. There may be 4 beams per group, and 2 beams overlap between consecutive groups. Thus, there are a total of 16 groups. In this configuration, a 4-bit feedback is used for the W1 matrix 120, a 2-bit feedback is used for the Y matrix 124 and a 2-bit feedback is used for the W2 matrix 122, resulting in 8 bits of total feedback. The fourth option also uses the same codebook size as the current R10 8Tx codebook.

The codebook size of the W1 matrix 120 can be flexibly designed based on the required beam resolution in azimuth and elevation. The beams of the W1 matrix 120 may be grouped into multiple groups with a grid of beams (GoB) from both elevation and azimuth. The W1 matrix 120 may be a new discrete Fourier transform (DFT) matrix for a 2×2 uniform planar array (UPA) that includes a total of N×M discrete Fourier transform (DFT) beams. The W2 matrix 122 may be a co-phasing matrix.

One advantage of using a two-dimensional discrete Fourier transform (2D-DFT) based codebook 112 is that it provides flexibility for joint optimization of elevation and azimuth. Another advantage of using a two-dimensional discrete Fourier transform (2D-DFT) based codebook 112 is that it reduces channel state information (CSI) feedback overhead. Using the two-dimensional discrete Fourier transform (2D-DFT) based codebook 112 may provide a performance gain of approximately 8%-10% over the LTE 8Tx dual codebook with the same codebook size. The two-dimensional discrete Fourier transform (2D-DFT) based codebook 112 may reuse the LTE Release-10 dual-codebook structure; thus the two-dimensional discrete Fourier transform (2D-DFT) based codebook 112 may be more easily accepted by 3GPP.

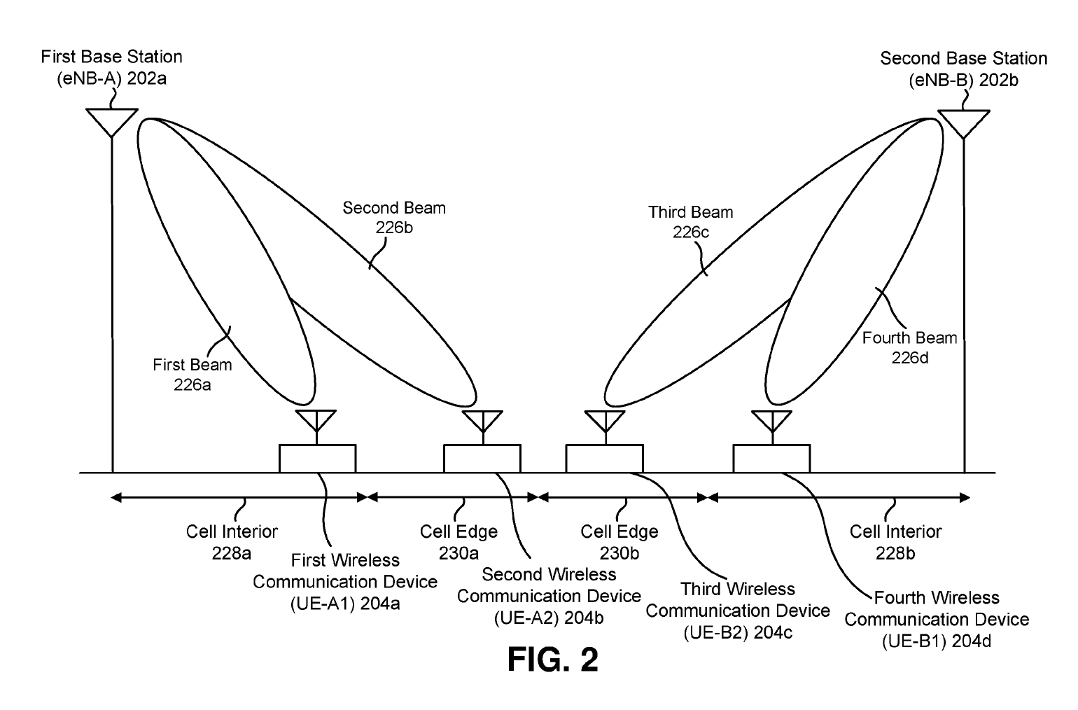

FIG. 2 is a diagram illustrating vertical sectorization in a wireless communication system. The wireless communication system may include a first base station (eNB-A) 202a and a second base station (eNB-B) 202b. The wireless communication system may also include a first wireless communication device (UE-A1) 204a and a second wireless communication device (UE-A2) 204b that communicate with the first base station (eNB-A) 202a. The wireless communication system may further include a third wireless communication device (UE-B2) 204c and a fourth wireless communication device (UE-B1) 204d that communicate with the second base station (eNB-B) 202b.

To improve transmissions in LTE, horizontal/vertical beamforming may be applied. The use of 3D-MIMO technology may greatly improve system capacity by using a two-dimensional antenna array with a large number of antennas at the base station 202 and a high beamforming gain. The associated physical downlink control channel (PDCCH) grant may be mapped to UE-specific search space. The first base station 202a (i.e., the serving eNB) may broadcast a common channel state information reference signal (CSI-RS) to all wireless communication devices 204. This allows the wireless communication devices 204 to select the best horizontal/vertical beam 226a-d from a set of fixed beams 226. Each horizontal/vertical beam 226 may be mapped to a preamble. The mapping of the preamble to the fixed horizontal/vertical beams 226 may be predefined so that the wireless communication device 204 knows the preamble after selecting the horizontal/vertical beam 226. The 3D-MIMO technology could greatly improve system capacity by using a two-dimensional antenna array with a large number of antennas at the base station 202, so as to achieve very small intra-cell interference and very high beamforming gain.

The first wireless communication device (UE-A1) 204a may be located within the cell interior 228a of the first base station (eNB-A) 202a, while the second wireless communication device (UE-A2) 204b is located on the cell edge 230a of the first base station (eNB-A) 202a. Likewise, the fourth wireless communication device (UE-B1) 204d may be located within the cell interior 228b of the second base station (eNB-B) 202b, while the third wireless communication device (UE-B2) 204c is located on the cell edge 230b of the second base station (eNB-B) 202b. Vertical sectorization using a 2D antenna array allows the first base station (eNB-A) 202a to create two vertical sectors, (the first beam 226a and the second beam 226b) rather than one azimuth sector. Likewise, the second base station (eNB-B) 202b may also create two vertical sectors (the third beam 226c and the fourth beam 226d). Horizontal sectorization may also be performed using the 2D antenna array.

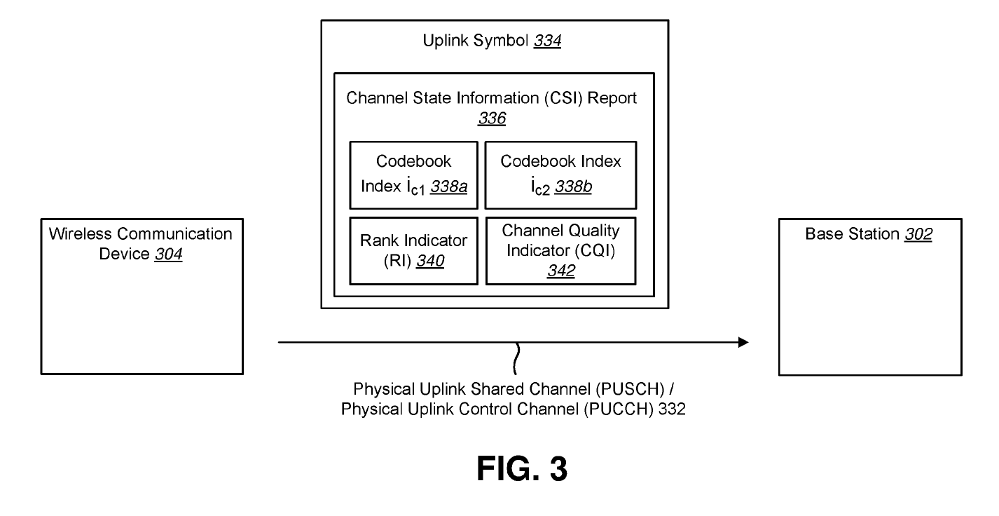

FIG. 3 is a block diagram illustrating a radio network operating in accordance with the systems and methods disclosed herein. A wireless communication device 304 may send a channel state information (CSI) report 336 in an uplink symbol 334 to a base station 302. In one configuration, the uplink symbol 334 is sent on a physical uplink shared channel (PUSCH) or a physical uplink control channel (PUCCH) 332.

The uplink symbol 334 may include channel state information (CSI) that may be used by the base station 302 to schedule wireless transmissions. In one configuration, the uplink symbol 334 may include a channel state information (CSI) report 336. The channel state information (CSI) report 336 may include a combination of channel quality indicator (CQI) 342 information, precoding matrix indicator (PMI) information (i.e., the codebook index ic1 338a and the codebook index ic2 338b) and rank indicator (RI) 340 information. The rank indicator (RI) 340 may indicate the number of layers that can be supported on a channel (e.g., the number of layers that the wireless communication device 304 can distinguish). Spatial multiplexing (in a MIMO transmission, for example) can be supported only when the rank indicator (RI) 340 is greater than 1. The precoding matrix indicator (PMI) may indicate a precoder out of a codebook (e.g., pre-agreed parameters) that the base station 302 may use for data transmission over multiple antennas based on the evaluation by the wireless communication device 304 of a received reference signal.

Similar to the Rel-10 8Tx codebook, in the two-dimensional discrete Fourier transform (2D-DFT) based codebook 112, the wireless communication device 304 will report a first codebook index ic1 338a and a second codebook index ic2 338b for the W1 matrix 120 and the W2 matrix 122. The W1 matrix 120 is a new discrete Fourier transform (DFT) matrix for a 2×2 uniform planar array (UPA) that includes a total of N×M discrete Fourier transform (DFT) beams. The W2 matrix 122 is a co-phasing matrix. The same W2 matrix 122 as used in the R10 8Tx codebook may be reused as the W2 matrix 122.

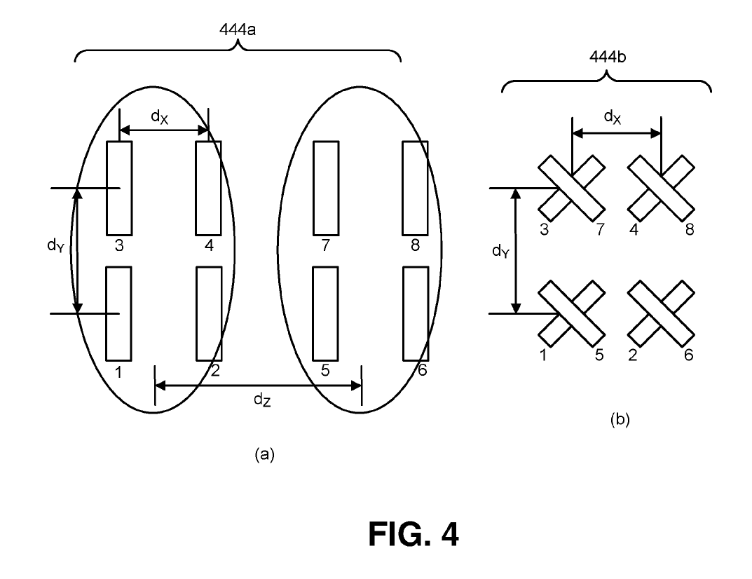

FIG. 4 is a diagram illustrating two-dimensional (2D) antenna arrays 444 for elevation beamforming. There are four types of two-dimensional (2D) uniform planar array (UPA) antenna arrays 444 that have 8 ports. In the two 2×4 configurations (which are capable of reusing the R10 8TX codebook), the R10 8Tx codebook may be reused. However, the 4×2 configurations (444a and 444b) require the use of a new codebook (i.e., the two-dimensional discrete Fourier transform (2D-DFT) based codebook 112 defined herein). In both of the two-dimensional (2D) uniform planar array (UPA) antenna arrays 444 shown, dx may be equal to 0.5λ, dy may be equal to 2.0λ, and dz may be equal to 4.0λ, where λ represents the wavelength.

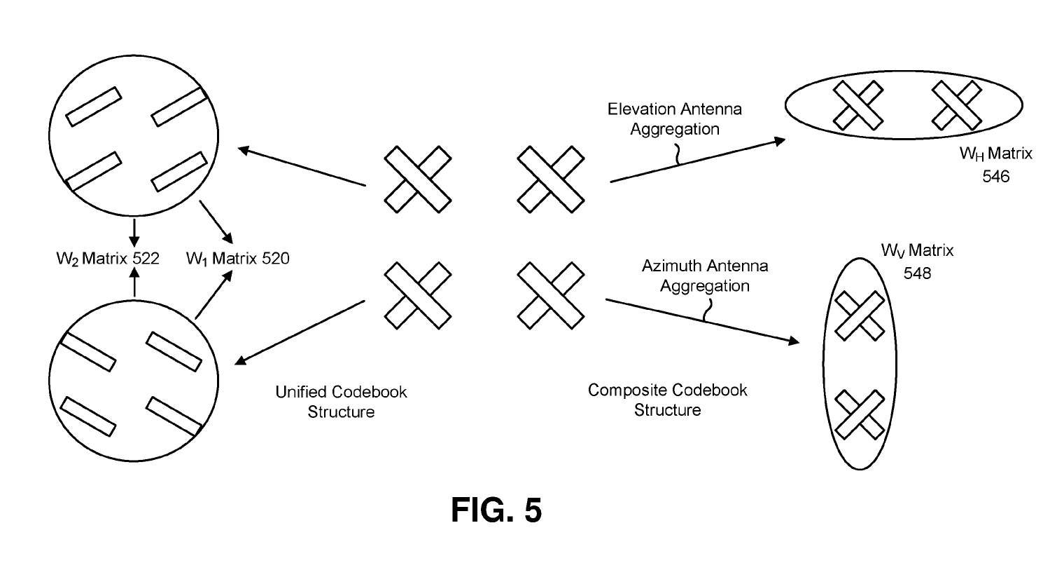

FIG. 5 illustrates the possible codebook structures for a two-dimensional (2D) antenna array. The codebook structure for a two-dimensional discrete Fourier transform (2D-DFT) based codebook 112 is a unified codebook. In a composite product codebook, the matrix W=W_{H}×(I_{NH} [symbol] W_{V}), where the W_{H} matrix 546 and the W_{V} matrix 548 are two codebooks for a subarray with cell specific aggregation. In contrast, in a unified dual codebook (i.e., a two-dimensional discrete Fourier transform (2D-DFT) based codebook 112), W=W1·W2, where the W1 matrix 520=[X 0; 0 Y] is block diagonal and the W2 matrix 522 is a 2×2 co-phasing matrix. Both the W1 matrix 520 and the W2 matrix 522 of the unified dual codebook are fully compatible with R10. The unified codebook provides flexibility for joint optimization of elevation and azimuth and to reduce the channel state information (CSI) feedback overhead.

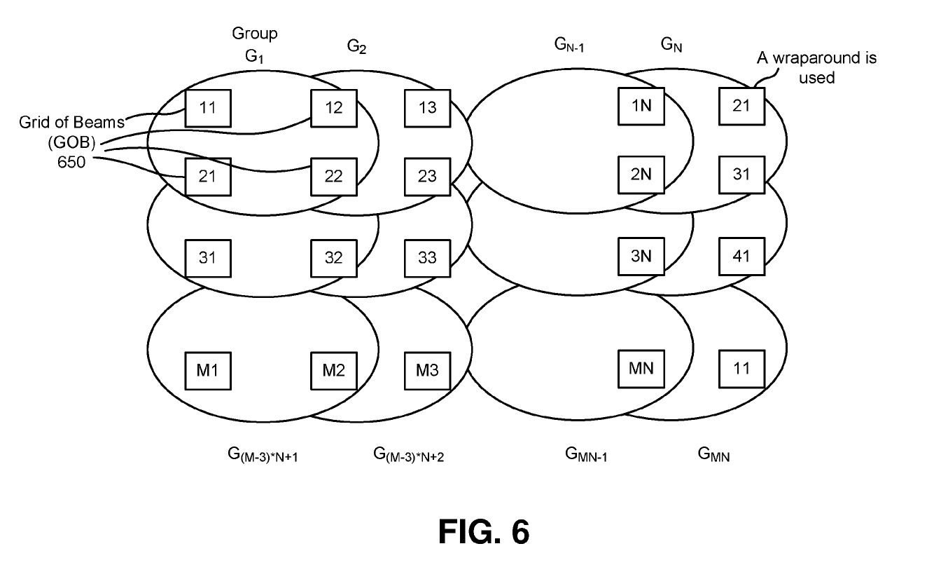

FIG. 6 is a block diagram illustrating that grouping of beams in the W1 matrix 120. Beams in the W1 matrix 120 may be grouped in multiple groups with a grid of beams (GOB) 650 from both elevation and azimuth. The groups may be overlapped in both elevation and azimuth. A grid of beams (GOB) 650 of four may be used in each group. A wrap around may also be used.

Similar to Rel-10 8Tx, the wireless communication device 104 may report a first codebook index i_{c1} 338a and a second codebook index i_{c2} 338b for the W₁ matrix 120 and the W₂ matrix 122, where the W₁ matrix 120 is a new discrete Fourier transform (DFT) matrix for a 2×2 uniform planar array (UPA) that includes a total of N×M discrete Fourier transform (DFT) beams, the W₂ matrix 122 is a co-phasing matrix (the same matrix as used in R10 8Tx can be reused as the W₂ matrix 122).

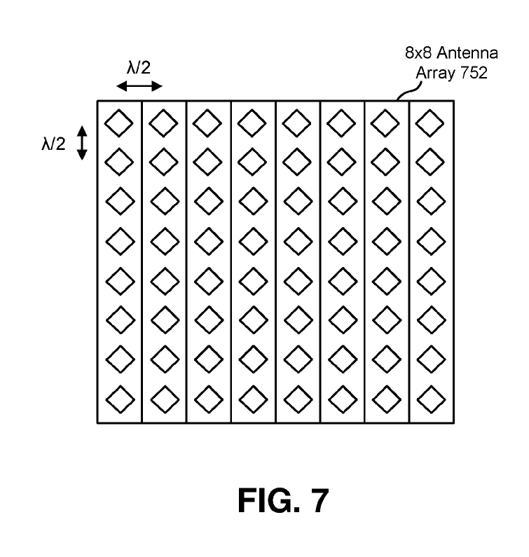

FIG. 7 is a block diagram illustrating a two-dimensional (2D) antenna array 752. The two-dimensional (2D) antenna array 752 shown is an 8×8 array with uniform antennas. Both azimuth and elevation elements may be active with individual transmitters and power amplifiers.

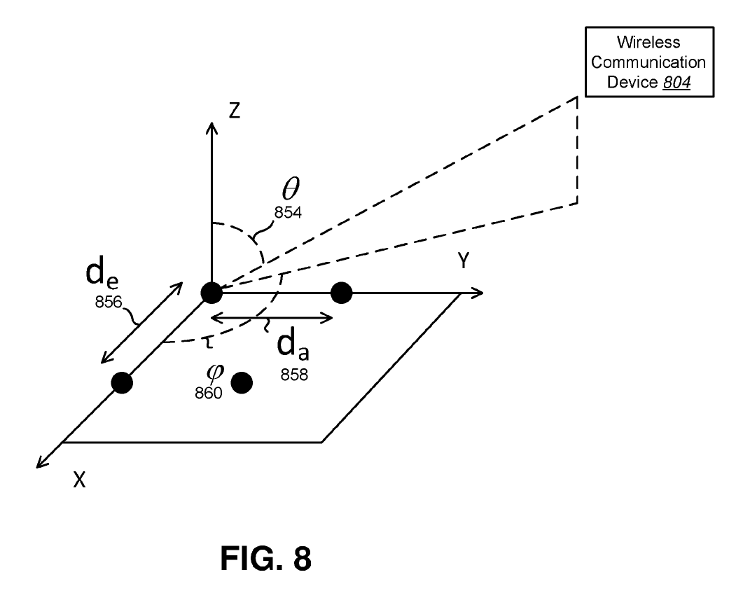

FIG. 8 illustrates steering vectors for use in a two-dimensional discrete Fourier transform (2D-DFT) based codebook 112 for a wireless communication device 804. The two-dimensional discrete Fourier transform (2D-DFT) based codebook 112 may be a unified codebook (as discussed above in relation to FIG. 5).

For an N×M two-dimensional uniform planar array (2D-UPA), the steering vector in the azimuth domain is given by Equation (1):

$$\begin{matrix}{a}_{r} ( ϕ , θ ) = {[ 1 {e}^{- j \frac{2 π}{λ} {d}_{a} cos ( ϕ ) sin ( θ ) } … {e}^{- j \frac{2 π}{λ} {d}_{a} ( N - 1 ) cos ( ϕ ) sin ( θ )} ]}^{T} \\ = {[ {e}^{- j 2 π μ} … {e}^{- j 2 π ( N - 1 ) μ} ]}^{T}\end{matrix} . \qquad ( 1 )$$

In Equation (1),

$$μ = \frac{1}{λ} {d}_{a} cos ( ϕ ) sin ( θ ) .$$

The variables dₐ 858, φ 860 and θ 854 of Equation (1) are illustrated in FIG. 8. For an N×M two-dimensional uniform planar array (2D-UPA), the steering vector in the elevation domain is given by Equation (2):

$$\begin{matrix}{a}_{c} ( ϕ , θ ) = {[ 1 {e}^{- j \frac{2 π}{λ} {d}_{e} sin ( ϕ ) sin ( θ ) } … {e}^{- j \frac{2 π}{λ} {d}_{e} ( M - 1 ) sin ( ϕ ) sin ( θ )} ]}^{T} \\ = {[ 1 {e}^{- j 2 π v} … {e}^{- j 2 π ( M - 1 ) v} ]}^{T}\end{matrix} . \qquad ( 2 )$$

In Equation (2),

$$v = \frac{1}{λ} {d}_{e} sin ( ϕ ) sin ( θ ) .$$

The variable dₑ 856 of Equation (2) is illustrated in FIG. 8. From Equation (1) and Equation (2), the combined steering vector may be described using Equation (3):

$$\begin{matrix}A ( ϕ , θ ) = vec ( {a}_{r} ( ϕ , θ ) {{a}_{c} ( ϕ , θ )}^{T} ) \\ = vec ( {a}_{r} ( μ ) {{a}_{c} ( v )}^{T} ) \\ = [ 1 {e}^{- j 2 π v} … {e}^{- j 2 π ( M - 1 ) v} {e}^{- j2 π μ} {e}^{- j2 π ( μ + v )} … \\ {e}^{- j2 π [ μ + ( M - 1 ) v ]} … {e}^{- j2π ( N - 1 ) μ} … \\ { {e}^{- j2 π [ ( N - 1 ) μ + ( M - 1 ) v ]} ]}^{T}\end{matrix} \qquad ( 3 )$$

An (N, M) two-dimensional discrete Fourier transform (2D-DFT) matrix W can be described using Equation (4):

$$w ( n , m ) = \frac{1}{\sqrt{NM}} [ 1 {e}^{- j2π \cdot 1 \cdot m} … {e}^{- j2π \cdot ( M - 1 ) \cdot m} {e}^{- j2 π \cdot 1 \cdot n} {e}^{- j 2 π \cdot [ 1 \cdot n + 1 \cdot m ]} … {e}^{- j 2 π [ 1 \cdot n + ( M - 1 ) m ]} … {e}^{- j 2 π [ ( N - 1 ) \cdot n ]} … {e}^{- j [ ( N - 1 ) n + ( M - 1 ) m ]} ] \qquad ( 4 )$$

In Equation (4),

$$n = 0 , \frac{1}{N} , \frac{2}{N} , … , \frac{N - 1}{N} , m = 0 , \frac{1}{M} , \frac{2}{M} , … , \frac{M - 1}{M} .$$

Comparing Equation (3) and Equation (4), the steering vector can be represented using Equation (4) by uniformly quantizing the azimuth vector

$$μ = \frac{{d}_{a} cos ( ϕ ) sin ( θ )}{λ}$$

with n and the elevation vector

$$v = \frac{{d}_{e} sin ( ϕ ) sin ( θ )}{λ}$$

with m. This allows for the building of the codebook for a two-dimensional (2D) uniform planar array (UPA) antenna array with a two-dimensional (2D) discrete Fourier transform (DFT) matrix.

Similarly, the two-dimensional discrete Fourier transform (2D-DFT) based codebook 112 for a two-dimensional (2D) uniform planar array (UPA) antenna array may be built by stacking the columns of the matrix product of the azimuth codebook and the elevation codebook. It may be assumed that the azimuth discrete Fourier transform (DFT) codebook is Bₐ={c₀^{a},c₁^{a}, . . . ,c_{P-1}^{a}} and the elevation discrete Fourier transform (DFT) codebook is Bₑ={c₀^{e},c₁^{e}, . . . ,c_{Q-1}^{e}}. Thus, the two-dimensional discrete Fourier transform (2D-DFT) based codebook 112 may be defined as B={c₀,c₁, . . . ,cₗ, . . . ,c_{PQ-1}}, where cₗ=vec[cₚ^{a}(c_{q}^{e})^{T}] and p=floor(l/Q), q=mod(l,Q).

A metric defined as

$$g ( ϕ , θ ) = {max}_{m} {\vert {f}_{m}^{T} a ( ϕ , θ ) \vert}^{2}$$

may be used to illustrate the codebook gain in a two-dimensional discrete Fourier transform (2D-DFT) based codebook 112. In the metric, fₘ is the codeword and a(φ,θ) is the steering vector of the two-dimensional (2D) uniform planar array (UPA) antenna array. From the comparison, the two-dimensional discrete Fourier transform (2D-DFT) based codebook 112 is shown to be better matched with a two-dimensional (2D) uniform planar array (UPA) antenna array than the LTE codebook.

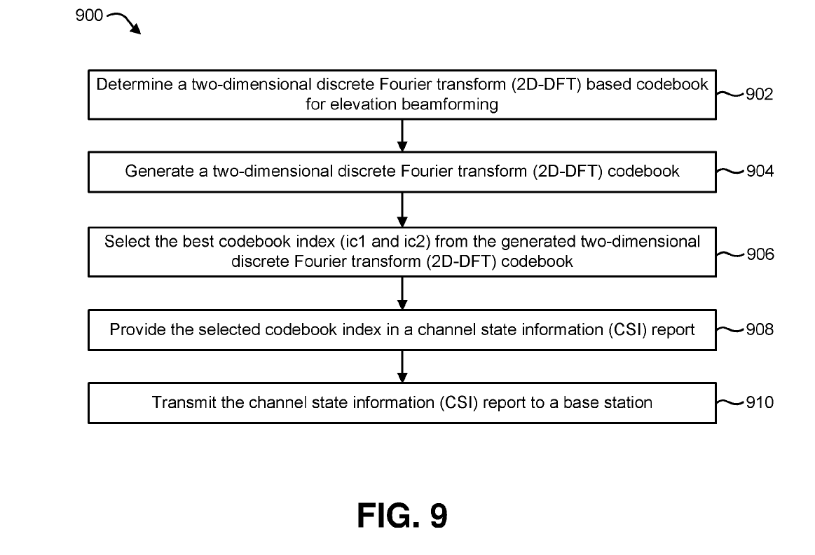

FIG. 9 is a flow diagram of a method 900 for channel state information (CSI) reporting using a two-dimensional discrete Fourier transform (2D-DFT) based codebook 112. The method 900 may be performed by a wireless communication device 104. In one configuration, the wireless communication device 104 may provide channel state information (CSI) reports 336 that correspond to an eight-port two-dimensional (2D) uniform planar array (UPA) antenna array.

The wireless communication device 104 may determine 902 a two-dimensional discrete Fourier transform (2D-DFT) based codebook 112 for elevation beamforming. For example, the wireless communication device 104 may decide to use a two-dimensional discrete Fourier transform (2D-DFT) based codebook 112 or a base station 102 may notify the wireless communication device 104 to use a two-dimensional discrete Fourier transform (2D-DFT) based codebook 112 (e.g., through radio resource control (RRC) signaling). The two-dimensional discrete Fourier transform (2D-DFT) based codebook 112 used by the wireless communication device 104 may be predefined.

The wireless communication device 104 may generate 904 a two-dimensional discrete Fourier transform (2D-DFT) based codebook 112 using the approach described above. The wireless communication device 104 may then select 906 the best codebook index (ic1 338a and ic2 338b) from the generated two-dimensional discrete Fourier transform (2D-DFT) based codebook 112. The wireless communication device 104 may provide 908 the selected codebook index 338 in a channel state information (CSI) report 339 as the PMI feedback. The wireless communication device 104 may then transmit 910 the channel state information (CSI) report 336 to a base station 102 (i.e., feedback the channel state information (CSI) report 336 in the PUSCH/PUCCH 332).

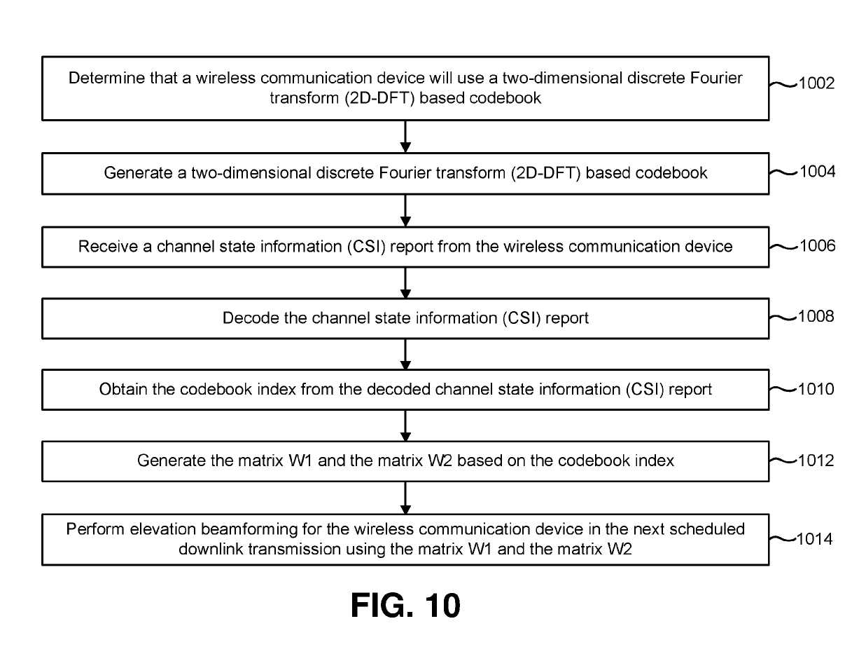

FIG. 10 is a flow diagram of a method 1000 for obtaining channel state information (CSI) reporting using a two-dimensional discrete Fourier transform (2D-DFT) based codebook 112. The method 1000 may be performed by a base station 102. In one configuration, the base station 102 may use a two-dimensional (2D) uniform planar array (UPA) antenna array for transmissions to a wireless communication device 104.

The base station 102 may determine 1002 that the wireless communication device 104 will use a two-dimensional discrete Fourier transform (2D-DFT) based codebook 112. In one configuration, the base station 102 may inform the wireless communication device 104 to use a two-dimensional discrete Fourier transform (2D-DFT) based codebook 112 (e.g., through RRC signaling). In another configuration, the base station 102 may obtain notification from the wireless communication device 104 that the wireless communication device 104 will use a two-dimensional discrete Fourier transform (2D-DFT) based codebook 112.

The base station 102 may generate 1004 a two-dimensional discrete Fourier transform (2D-DFT) based codebook 112 as described above. The base station 102 may receive 1006 a channel state information (CSI) report 336 from the wireless communication device 104. The channel state information (CSI) report 336 may be received on the PUSCH/PUCCH 332. The base station 102 may decode 1008 the channel state information (CSI) report 336. The base station 102 may obtain 1010 the codebook index (ic1 338a and ic2 338b) from the decoded channel state information (CSI) report 336. Decoding channel state information (CSI) reports 336 is the common channel state information (CSI) decoding procedure. The base station 102 may generate 1012 the matrix W1 122 and the matrix W2 120 based on the codebook index 338 feedback from the wireless communication device 104. The base station 102 may then perform 1014 elevation beamforming for the wireless communication device 104 in the next scheduled downlink transmission using the matrix W1 120 and the matrix W2 122.

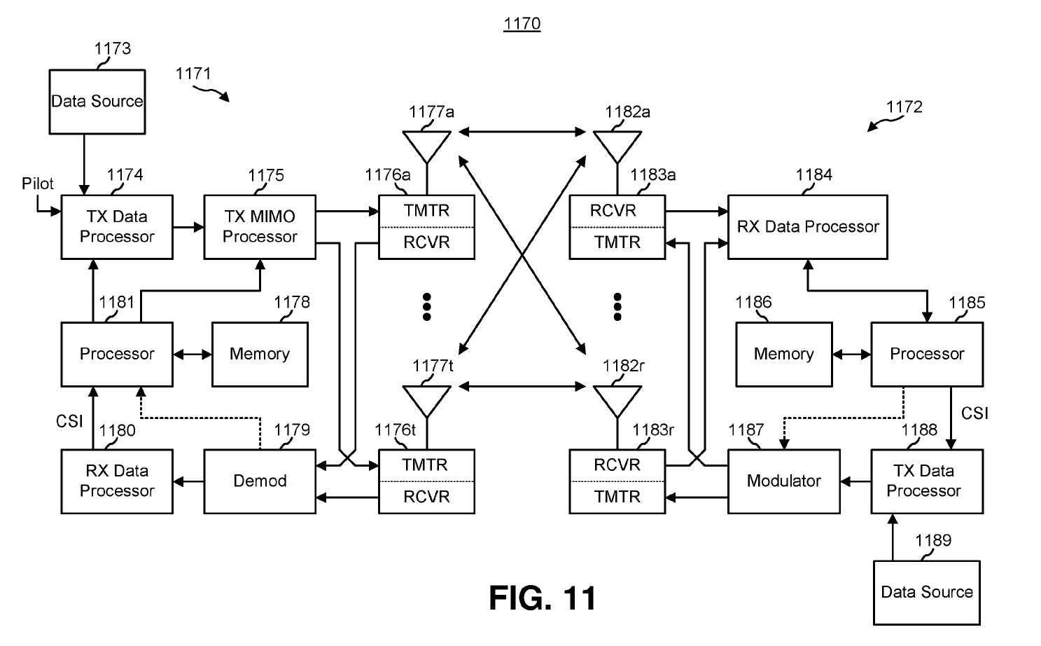

FIG. 11 is a block diagram of a transmitter 1171 and receiver 1172 in a multiple-input and multiple-output (MIMO) system 1170. In the transmitter 1171, traffic data for a number of data streams is provided from a data source 1173 to a transmit (TX) data processor 1174. Each data stream may then be transmitted over a respective transmit antenna 1177a through 1177t. The transmit (TX) data processor 1174 may format, code, and interleave the traffic data for each data stream based on a particular coding scheme selected for that data stream to provide coded data.

The coded data for each data stream may be multiplexed with pilot data using OFDM techniques. The pilot data may be a known data pattern that is processed in a known manner and used at the receiver 1172 to estimate the channel response. The multiplexed pilot and coded data for each stream is then modulated (i.e., symbol mapped) based on a particular modulation scheme (e.g., binary phase shift keying (BPSK), quadrature phase shift keying (QPSK), multiple phase shift keying (M-PSK) or multi-level quadrature amplitude modulation (M-QAM)) selected for that data stream to provide modulation symbols. The data rate, coding and modulation for each data stream may be determined by instructions performed by a processor.

The modulation symbols for all data streams may be provided to a transmit (TX) multiple-input multiple-output (MIMO) processor 1175, which may further process the modulation symbols (e.g., for OFDM). The transmit (TX) multiple-input multiple-output (MIMO) processor 1175 then provides NT modulation symbol streams to NT transmitters (TMTR) 1176a through 1176t. The transmit (TX) multiple-input multiple-output (MIMO) processor 1175 may apply beamforming weights to the symbols of the data streams and to the antenna 1177 from which the symbol is being transmitted.

Each transmitter 1176 may receive and process a respective symbol stream to provide one or more analog signals, and further condition (e.g., amplify, filter and upconvert) the analog signals to provide a modulated signal suitable for transmission over the multiple-input and multiple-output (MIMO) channel. NT modulated signals from transmitters 1176a through 1176t are then transmitted from NT antennas 1177a through 1177t, respectively.

At the receiver 1172, the transmitted modulated signals are received by NR antennas 1182a through 1182r and the received signal from each antenna 1182 is provided to a respective receiver (RCVR) 1183a through 1183r. Each receiver 1183 may condition (e.g., filter, amplify and downconvert) a respective received signal, digitize the conditioned signal to provide samples, and further process the samples to provide a corresponding “received” symbol stream.

An RX data processor 1184 then receives and processes the NR received symbol streams from NR receivers 1183 based on a particular receiver processing technique to provide NT “detected” symbol streams. The RX data processor 1184 then demodulates, deinterleaves and decodes each detected symbol stream to recover the traffic data for the data stream. The processing by RX data processor 1184 is complementary to that performed by TX multiple-input and multiple-output (MIMO) processor 1175 and TX data processor 1174 at transmitter system 1171.

A processor 1185 may periodically determine which pre-coding matrix to use. The processor 1185 may store information on and retrieve information from memory 1186. The processor 1185 formulates a reverse link message comprising a matrix index portion and a rank value portion. The reverse link message may be referred to as channel state information (CSI). The reverse link message may comprise various types of information regarding the communication link and/or the received data stream. The reverse link message is then processed by a TX data processor 1188, which also receives traffic data for a number of data streams from a data source 1189, modulated by a modulator 1187, conditioned by transmitters 1183a through 1183r, and transmitted back to the transmitter 1171.

At the transmitter 1171, the modulated signals from the receiver 1172 are received by antennas 1177, conditioned by receivers 1176, demodulated by a demodulator 1179, and processed by an RX data processor 1180 to extract the reverse link message transmitted by the receiver system 1172. A processor 1181 may receive channel state information (CSI) from the RX data processor 1180. The processor 1181 may store information on and retrieve information from memory 1178. The processor 1181 then determines which pre-coding matrix to use for determining the beamforming weights and then processes the extracted message.

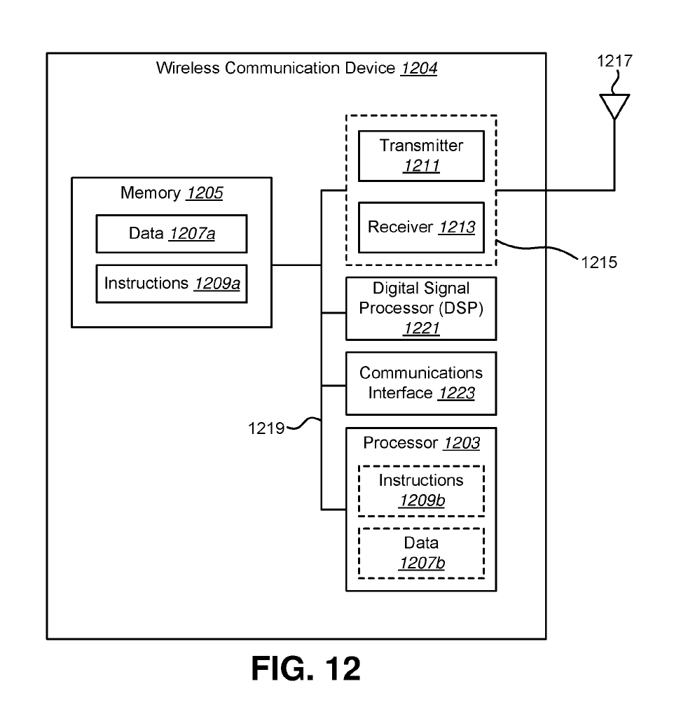

FIG. 12 illustrates certain components that may be included within a wireless communication device 1204. The wireless communication device 1204 may be an access terminal, a mobile station, a user equipment (UE), etc. The wireless communication device 1204 includes a processor 1203. The processor 1203 may be a general purpose single- or multi-chip microprocessor (e.g., an ARM), a special purpose microprocessor (e.g., a digital signal processor (DSP)), a microcontroller, a programmable gate array, etc. The processor 1203 may be referred to as a central processing unit (CPU). Although just a single processor 1203 is shown in the wireless communication device 1204 of FIG. 12, in an alternative configuration, a combination of processors (e.g., an ARM and DSP) could be used.

The wireless communication device 1204 also includes memory 1205. The memory 1205 may be any electronic component capable of storing electronic information. The memory 1205 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 1207a and instructions 1209a may be stored in the memory 1205. The instructions 1209a may be executable by the processor 1203 to implement the methods disclosed herein. Executing the instructions 1209a may involve the use of the data 1207a that is stored in the memory 1205. When the processor 1203 executes the instructions 1209a, various portions of the instructions 1209b may be loaded onto the processor 1203, and various pieces of data 1207b may be loaded onto the processor 1203.

The wireless communication device 1204 may also include a transmitter 1211 and a receiver 1213 to allow transmission and reception of signals to and from the wireless communication device 1204. The transmitter 1211 and receiver 1213 may be collectively referred to as a transceiver 1215. An antenna 1217 may be electrically coupled to the transceiver 1215. The wireless communication device 1204 may also include (not shown) multiple transmitters, multiple receivers, multiple transceivers and/or additional antennas.

The wireless communication device 1204 may include a digital signal processor (DSP) 1221. The wireless communication device 1204 may also include a communications interface 1223. The communications interface 1223 may allow a user to interact with the user equipment (UE) 1204.

The various components of the wireless communication device 1204 may be coupled together by one or more buses, which may include a power bus, a control signal bus, a status signal bus, a data bus, etc. For the sake of clarity, the various buses are illustrated in FIG. 12 as a bus system 1219.

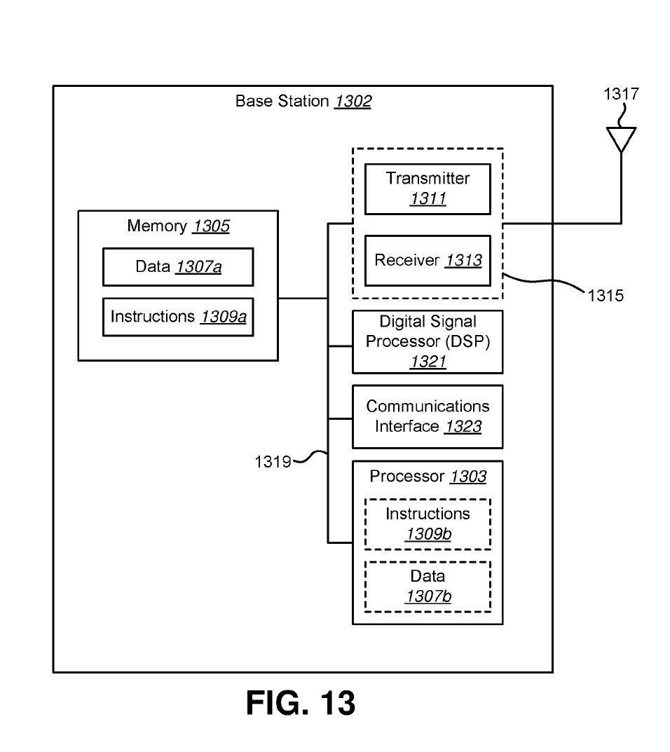

FIG. 13 illustrates certain components that may be included within a base station 1302. A base station 1302 may also be referred to as, and may include some or all of the functionality of, an access point, a broadcast transmitter, a NodeB, an evolved NodeB, etc. The base station 1302 includes a processor 1303. The processor 1303 may be a general purpose single- or multi-chip microprocessor (e.g., an ARM), a special purpose microprocessor (e.g., a digital signal processor (DSP)), a microcontroller, a programmable gate array, etc. The processor 1303 may be referred to as a central processing unit (CPU). Although just a single processor 1303 is shown in the base station 1302 of FIG. 13, in an alternative configuration, a combination of processors (e.g., an ARM and DSP) could be used.

The base station 1302 also includes memory 1305. The memory 1305 may be any electronic component capable of storing electronic information. The memory 1305 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 1307a and instructions 1309a may be stored in the memory 1305. The instructions 1309a may be executable by the processor 1303 to implement the methods disclosed herein. Executing the instructions 1309a may involve the use of the data 1307a that is stored in the memory 1305. When the processor 1303 executes the instructions 1309a, various portions of the instructions 1309b may be loaded onto the processor 1303, and various pieces of data 1307b may be loaded onto the processor 1303.

The base station 1302 may also include a transmitter 1311 and a receiver 1313 to allow transmission and reception of signals to and from the base station 1302. The transmitter 1311 and receiver 1313 may be collectively referred to as a transceiver 1315. An antenna 1317 may be electrically coupled to the transceiver 1315. The base station 1302 may also include (not shown) multiple transmitters, multiple receivers, multiple transceivers and/or additional antennas.

The base station 1302 may include a digital signal processor (DSP) 1321. The base station 1302 may also include a communications interface 1323. The communications interface 1323 may allow a user to interact with the base station 1302.

The various components of the base station 1302 may be coupled together by one or more buses, which may include a power bus, a control signal bus, a status signal bus, a data bus, etc. For the sake of clarity, the various buses are illustrated in FIG. 13 as a bus system 1319.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

No claim element is to be construed under the provisions of 35 U.S.C. §112, sixth paragraph, unless the element is expressly recited using the phrase “means for” or, in the case of a method claim, the element is recited using the phrase “step for.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 9-10, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods and apparatus described herein without departing from the scope of the claims.

What is claimed is:

1. A method for channel state information reporting, comprising:
determining a two-dimensional discrete Fourier transform based codebook for elevation beamforming, wherein the codebook supports single stream codewords and multistream codewords;
generating the two-dimensional discrete Fourier transform based codebook;
selecting a best codebook index from the generated two-dimensional discrete Fourier transform based codebook;
providing the selected codebook index in a channel state information report; and
transmitting the channel state information report to a base station.

2. The method of claim 1, wherein the method is performed by a wireless communication device.

3. The method of claim 2, wherein the wireless communication device reports two codebook indexes ic1 and ic2 for a W1 matrix and a W2 matrix.

4. The method of claim 3, wherein the channel state information for the W1 matrix is built by stacking the columns of the matrix product of two discrete Fourier transform codebook matrices.

5. The method of claim 3, wherein a codebook size of the W1 matrix is flexibly designed based on required beam resolution in azimuth and elevation.

6. The method of claim 3, wherein beams of the W1 matrix are grouped into multiple groups with a grid of beams from both elevation and azimuth.

7. The method of claim 6, wherein beam groups are overlapped.

8. The method of claim 6, wherein beam groups are non-overlapped.

9. The method of claim 6, wherein a wrap around is used.

10. The method of claim 3, wherein the W2 matrix is a co-phasing matrix.

11. The method of claim 3, wherein a matrix from Rel-10 8Tx is reused as the W2 matrix.

12. A method for transmission by a base station, comprising:
determining that a wireless communication device will use a two-dimensional discrete Fourier transform based codebook, wherein the codebook supports single stream codewords and multistream codewords;
generating a two-dimensional discrete Fourier transform based codebook;
receiving a channel state information report from the wireless communication device;
decoding the channel state information report;
obtaining a codebook index from the decoded channel state information report;
generating a first matrix and a second matrix based on the codebook index; and
performing elevation beamforming for the wireless communication device in a next scheduled downlink transmission using the first matrix and the second matrix.

13. The method of claim 12, wherein the first matrix is a W1 matrix and the second matrix is a W2 matrix.

14. The method of claim 13, wherein the wireless communication device reports two codebook indexes ic1 and ic2 for the W1 matrix and the W2 matrix.

15. The method of claim 14, wherein the two-dimensional discrete Fourier transform based codebook for the W1 matrix is built by stacking the columns of the matrix product of two discrete Fourier transform codebook matrices.

16. The method of claim 14, wherein a codebook size of the W1 matrix is flexibly designed based on required beam resolution in azimuth and elevation.

17. The method of claim 14, wherein beams of the W1 matrix are grouped into multiple groups with a grid of beams from both elevation and azimuth.

18. The method of claim 17, wherein beam groups are overlapped.

19. The method of claim 17, wherein beam groups are non-overlapped.

20. The method of claim 17, wherein a wrap around is used.

21. The method of claim 14, wherein the W2 matrix is a co-phasing matrix.

22. The method of claim 14, wherein a matrix from Rel-10 8Tx is reused as the W2 matrix.

23. An apparatus for channel state information reporting, comprising:
a processor;
memory in electronic communication with the processor; and
instructions stored in the memory, the instructions being executable by the processor to:
determine a two-dimensional discrete Fourier transform based codebook for elevation beamforming, wherein the codebook supports single stream codewords and multistream codewords;
generate the two-dimensional discrete Fourier transform based codebook;
select a best codebook index from the generated two-dimensional discrete Fourier transform based codebook;
provide the selected codebook index in a channel state information report; and
transmit the channel state information report to a base station.

24. The apparatus of claim 23, wherein the apparatus is a wireless communication device.

25. The apparatus of claim 24, wherein the wireless communication device reports two codebook indexes ic1 and ic2 for a W1 matrix and a W2 matrix.

26. The apparatus of claim 25, wherein the channel state information for the W1 matrix is built by stacking the columns of the matrix product of two discrete Fourier transform codebook matrices.

27. The apparatus of claim 25, wherein a codebook size of the W1 matrix is flexibly designed based on required beam resolution in azimuth and elevation.

28. The apparatus of claim 25, wherein beams of the W1 matrix are grouped into multiple groups with a grid of beams from both elevation and azimuth.

29. The apparatus of claim 28, wherein beam groups are overlapped.

30. The apparatus of claim 28, wherein beam groups are non-overlapped.
